(19) United States
(12) Patent Application Publication
(10) Pub. No.: US 2017/0131491 A1
(43) Pub. Date: May 11, 2017

(54) HYBRID PIN CONNECTING APPARATUS FOR OPTOELECTRONIC DEVICES

(71) Applicant: Coriant Advanced Technology LLC, New York, NY (US)

(72) Inventors: Asres Y. Seyoum, Santa Barbara, CA (US); Nathan A. Nuttall, Castaic, CA (US)

(21) Appl. No.: 14/936,884

(22) Filed: Nov. 10, 2015

(51) Int. Cl. G02B 6/42

(52) U.S. Cl. CPC G02B 6/4245; G02B 6/428; G02B 6/4279; G02B 6/4257; G02B 6/4238; G02B 6/4284

(57) ABSTRACT

A hybrid pin connecting apparatus and method for connecting a thermally susceptible high-speed optoelectronic device to a PCB, comprising a combination of one or more flat pins or gull wing pins capable of transmitting high-speed electrical signals above 5 Gbps for being locally soldered to one or more matching surface mount pads on the PCB, and a pin grid array capable of transmitting only low-speed electrical signals below 5 Gbps mounted on the substrate for fitting into and connecting to a geometrically matching array of through-hole connections on the PCB.

### TECHNICAL FIELD

The present invention relates in general to an apparatus and a method for connecting substrate mounted optoelectronic and electronic devices to a system board, and in particular to a hybrid pin connecting apparatus combining high-speed and low-speed pin arrays to reduce connecting apparatus size and cost of production and to prevent damage to device components susceptible to structural failure at the high temperatures of reflow soldering.

### BACKGROUND

Optoelectronic devices in high-speed data transport or data communication systems may typically comprise interconnected optical and electrical components that widely vary in performance and function. Commonly such components are mounted on a substrate that provides physical support and electrical interconnections therefor. The substrate is in turn connected to a system board in such a way as to be capable of transmitting high-speed electrical data above 5 Gbps between the substrate and the system board. There is also a typical requirement for a large number of pin connections between the substrate and the system board as dictated by the intended function of the optoelectronic device. Furthermore, some of the components, interconnections or joints of the optoelectronic device cannot be exposed to a standard reflow soldering process for connecting the optoelectronic device to a system board due to their susceptibility to structural failure at the high temperatures above 217 degrees Celsius used in this soldering process for melting the solder material.

Conventional prior art connectors fail to meet one or more of the aforementioned requirements of high-speed data transmission, large number of pin connections, and using means other than reflow soldering to avoid exposing the optoelectronic device components to high temperatures. One prior art connector is a ball grid array (BGA), which is a type of surface-mount packaging for connecting an integrated circuit (IC) chip to a system board, but this type of connector would require reflow soldering. Another prior art connector is a Pin Grid Array (PGA) used for connecting an electronic device to a printed circuit board (PCB), but this type of connector would not be able to transmit high-speed electrical signals, especially those above 5 Gbps. Yet another prior art connector is a flat pin assembly for transmitting high-speed electrical signals between an electronic device and a PCB, but this type of connector would not allow a sufficient number of pins unless the packaging size is made prohibitively large. Of particular relevance is a conventional land grid array (LGA), which is a type of surface-mount assembly for connecting an integrated circuits (IC) package having the pins on an electrical interposer rather than on the IC package. The IC package is in turn connected to a system board via an electrical interposer. It might be possible to adapt the LGA configuration in order to meet all three aforementioned requirements of transmitting high-speed signal, avoiding reflow soldering, and maintaining a relatively small packaging size, but this arrangement would require an additional compression system, the cost of which could be relatively high.

An object of the present invention is therefore to overcome shortcomings of the prior art by providing an economical and compact electrical connection arrangement that can be implemented in a practically small packaging size while being capable of transmitting high-speed signals above 5 Gbps between an optoelectronic device and a system board without exposing the optoelectronic device to the high temperatures typically associated with the reflow soldering process. To meet this object, the arrangement disclosed herein provides a hybrid pin connecting apparatus with separate pin arrays for the high-speed signals and lower-speed signals.

### SUMMARY OF THE INVENTION

Accordingly, the present invention relates to a high-speed optoelectronic device comprising: a photonic integrated circuit; a substrate supporting and electrically connected to the photonic integrated circuit; and a hybrid pin array connected to the substrate for electrically connecting the optoelectronic device to a system board, said hybrid pin array including a perimeter pin array capable of transmitting high-speed electrical signals above 5 Gbps; and a pin grid array capable of transmitting only low-speed electrical signals below 5 Gbps for aligning the substrate to the system board and for insertion into and connecting to a geometrically matching array of through-hole connections on the system board. Another aspect of the present invention relates to a method of electrically connecting a high-speed optoelectronic device to a system board, wherein said optoelectronic device includes a photonic integrated circuit mounted on and electrically connected to a substrate and is susceptible to structural failure at high temperatures, said method comprising establishing a hybrid electrical connection between the substrate and the system board, including establishing a first electrical connection capable of transmitting high-speed electrical signals above 5 Gbps, and establishing a second electrical connection capable of transmitting only low-speed electrical signals below 5 Gbps. Yet another aspect of the present invention relates to a hybrid pin array apparatus attached and electrically connected to a substrate for connecting to a system board a high-speed optoelectronic device susceptible to structural failure at high temperatures and electrically connected to the substrate, said hybrid pin array apparatus comprising: a perimeter pin array capable of transmitting high-speed electrical signals above 5 Gbps; and a pin grid array capable of transmitting only low-speed electrical signals below 5 Gbps for insertion into and electrically connecting to a geometrically matching array of through-hole connections on the system board and for aligning the substrate to the system board.

### BRIEF DESCRIPTION OF THE DRAWINGS

The invention will be described in greater detail with reference to the accompanying drawings which represent preferred embodiments thereof, wherein:

FIG. 1A illustrates a cross-section view of a high-speed optoelectronic device using flat pins for transmitting high-speed electrical signals in accordance with a first embodiment of the present invention;

FIG. 1B illustrates a cross-section view of a high-speed optoelectronic device using gull wing pins for transmitting high-speed electrical signals and RF signals in accordance with a second embodiment of the present invention;

FIG. 2A illustrates a cross-section view of a configuration for connecting the device of FIG. 1A to a system board; and

FIG. 2B illustrates a cross-sectional view a configuration for connecting the device of FIG. 1B to a system board.

In the drawings, like numerals are used to indicate like parts throughout the various diagrams. The drawings are not necessarily to scale, emphasis instead generally being placed upon illustrating the principles of the invention.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

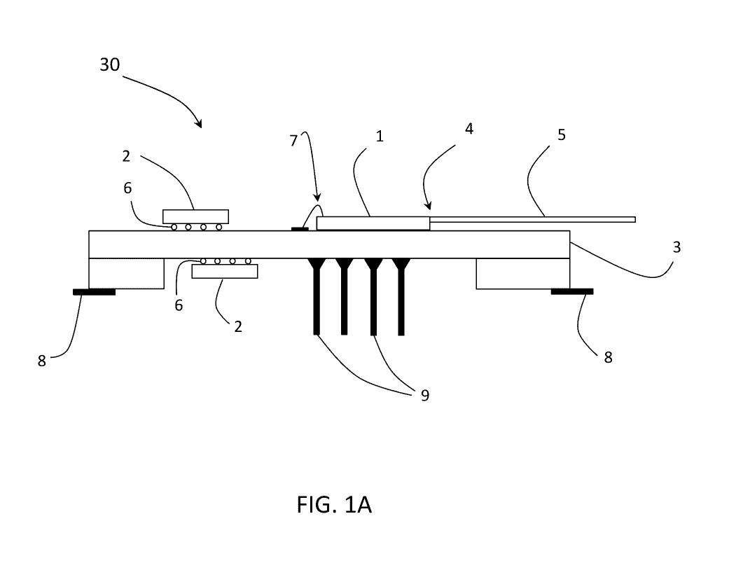

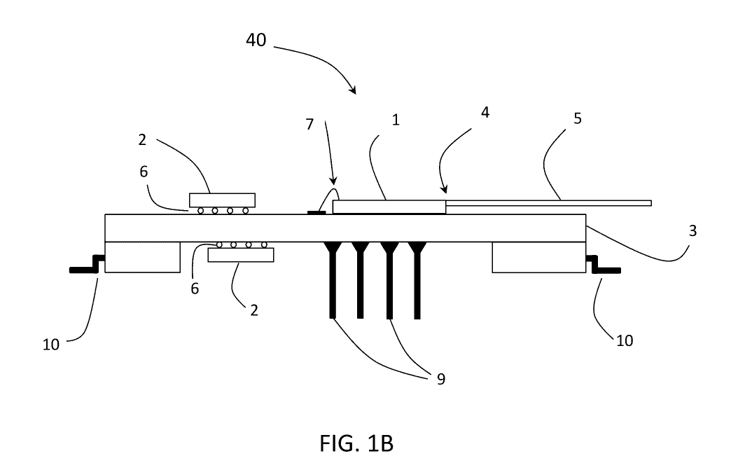

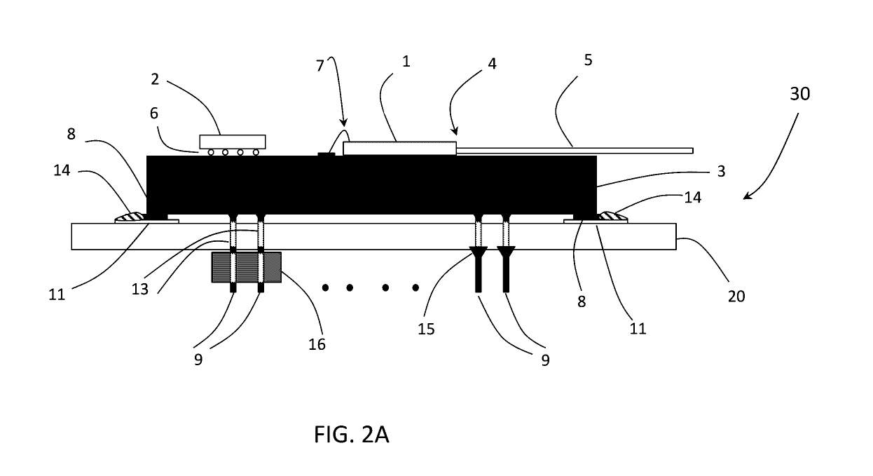

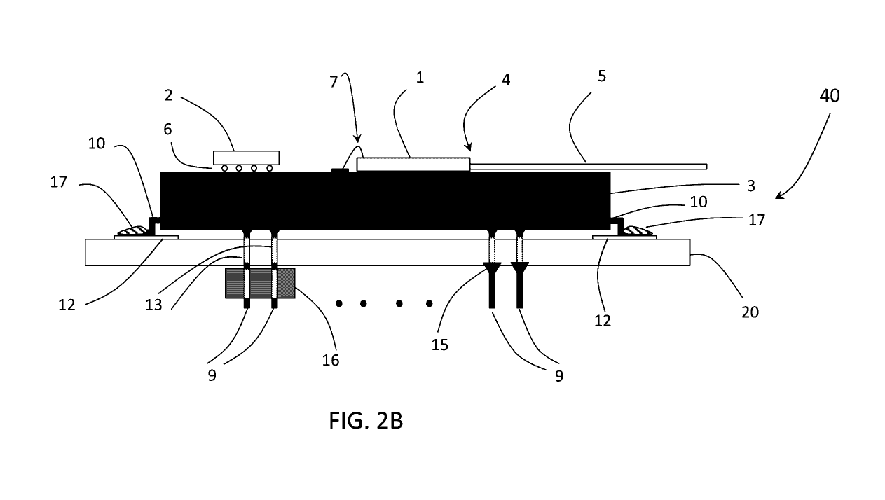

With reference to FIGS. 1A, 1B, 2A and 2B, the hybrid electrical connector apparatus, the high-speed optoelectronic and electronic device operating at data speeds above 5 Gbps, and the hybrid connection apparatus according to a preferred embodiment of the present invention are specifically for connecting said device to a system board. This embodiment provides a combination of a perimeter pin array capable of transmitting high-speed electrical signals above 5 Gbps and a pin grid array capable of transmitting only low-speed electrical signals below 5 Gbps.

FIGS. 1A and 1B illustrate two high-speed optoelectronic devices 30 and 40 respectively according to two exemplary embodiments of the present invention, each including a diversity of optical, electronic, and optoelectronic circuit components mounted on a substrate 3 for physical support and interconnection thereof. These circuit components may include a photonic integrated circuit (PIC) 1, and one or more integrated circuits (IC) 2, which can be mounted on either or both top and bottom surfaces of the substrate 3, for ease and integrity of mechanical or electrical connections. The PIC 1 may be optically coupled to an optical fiber 5 by an optical joint 4, such as an epoxy adhesive joint, and electrically connected to the substrate 3 and other components via one or more wire bonds 7. The optical fiber 5, the optical joint 4, and the wire bond 7 are typically thermally sensitive components, e.g. being susceptible to structural failure when exposed to the high temperature of a reflow soldering process needed to melt the solder materials, which is typically above 217 degrees Celsius. The PIC 1 converts the high-speed optical signals received from the optical fiber 5 to high-speed electrical signals sent to the substrate 3 via the wire bond 7 and vice versa. The IC's 2 are electrically connected to the substrate 3 by a conventional connection arrangement, which can be a ball grid array (BGA) 6 as shown in FIGS. 1A and 1B, or an array of wire bonds (not shown). Connected to the substrate 3 is a hybrid arrangement of pins as described herein for transmitting electrical signals of different speeds including: a pin grid array (PGA) 9 for delivering DC power signals required to power the aforementioned diversity of circuit components, and for transmitting low-speed electrical signals typically below 5 Gbps relevant to the overall functioning of the optoelectronic devices 30 and 40; and a pin array 8 specifically designed in accordance with prior art for transmitting the high-speed electrical signals of the PIC 1. The high-speed pin array can be one or more flat pins 8 as shown in FIG. 1A, or one or more gull wing pins 10 as shown in FIG. 1B, designed in accordance with prior art for transmitting the high-speed electrical signals and RF signals within a particular range of relevance to the optoelectronic devices 30 and 40 with minimum electrical disturbances.

FIGS. 2A and 2B illustrate first and second exemplary embodiments in accordance with the present invention, for connecting the high-speed optoelectronic devices 30 and 40 shown in FIGS. 1A and 1B, respectively, to a system board, which in this instance is shown as a printed circuit board (PCB) 20. The PCB 20 includes an array of through-hole connections 13 extending through the PCB 20 for accommodating the PGA 9 with a matching footprint and for aligning the substrate 3 to the PCB 20. In the first embodiment shown in FIG. 2A, one or more first surface mount pads 11 may be mounted on an upper side of the PCB 20 facing the substrate 3 and matching in relative positions the flat pins 8. In the second embodiment shown in FIG. 2B, one or more second surface mount pads 12 may be mounted on the upper side of the PCB 20 facing the substrate 3 and matching in relative positions the gull wing pins 10. In each of the first and second embodiments, the substrate 3 is placed on the upper side of the PCB 20 and the PGA 9 is aligned to the array of through-hole connections 13 and inserted thereinto. Electrical connections between the substrate 3 and the PCB 20 can be established thereafter for different signal speeds, namely: a first electrical connection, between the flat pins 8 or the gull wing pins 10 and the surface mount pads 11 or 12, for transmitting the high-speed electrical signals and a second electrical connection, between the PGA 9 and the through-hole connections 13, for transmitting the low-speed and DC power signals.

As shown in FIG. 2A for the first embodiment, the first electrical connection may be established with a first local soldering joint 14 created by connecting the flat pin 8 to the first surface mount pad 11 by a local soldering process that does not practically increase the temperature of the aforementioned thermally sensitive components 1, 4 and 5. Alternatively, the first electrical connection may be established for the second embodiment as shown in FIG. 2B with a second local soldering joint 17 created by connecting the gull wing pin 10 to the second surface mount pad 12 by a local soldering process that does not practically increase the temperature of the aforementioned thermally sensitive components. As shown in FIGS. 2A and 2b, the second electrical connection may be established by creating an array of local soldering joints 15 by inserting the PGA 9 into the array of through-hole connections 13, and then connecting the PGA 9 to the PCB 20 in either a first arrangement, a second arrangement or a combination thereof. In the first arrangement, the PGA 9 is electrically connected to the array of through-hole connections 13 at the lower side of the PCB 20 by a local soldering process that does not practically increase the temperature of the aforementioned thermally sensitive components. In the second arrangement, the PGA 9 is socketed, i.e. frictionally coupled, to a matching bottom entry connector socket 16 mounted on the lower side of the PCB 20 opposite to the substrate 3.

Advantageously, the present invention eliminates the need for a reflow soldering process for any of the aforementioned electrical connectors, which can expose the aforementioned thermally susceptible device components 1, 4 and 5 and any other thermally susceptible device components to the high temperatures likely to cause structural failure thereto. At the same time the present invention provides a sufficient number of connections for the high and low speed signals in a more economical and compact arrangement than prior art. In view of the crucial importance of providing high-speed data communication devices with adequate connectors for transmitting the high-speed electrical signals and reducing device size, the present invention provides separate connectors for the high-speed and low-speed electrical signals. If otherwise, device size was not critical, signals of all speeds could be connected to flat pins mounted on the substrate perimeter edge thus not necessarily requiring the hybrid connection configuration. The present invention is advantageously used: where there is a need to provide connectivity for a high number of electrical signals between a system board and an electronic or optoelectronic device that is susceptible to structural failure at the high temperatures of reflow soldering process; when part of the electrical signals are high speed signals and part are low speed and power signals; and when it is not practical or economical to use an interposer or a socket to connect the electronic or optoelectronic device to a system board. Moreover, the selection of high-speed connector is decoupled from the selection of low-speed connector enabling their selections to be optimized according to individual requirements and cost.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. For example, the PGA 9 can be shaped to form an array of press-fit pins that is frictionally inserted into the array of through-hole connections 13 as an alternative to the array of local soldering joints 15.

We claim:

1. A high-speed optoelectronic device comprising:
a photonic integrated circuit;
a substrate supporting and electrically connected to the photonic integrated circuit; and
a hybrid pin array connected to the substrate for electrically connecting the optoelectronic device to a system board, said hybrid pin array including a perimeter pin array capable of transmitting high-speed electrical signals above 5 Gbps; and a pin grid array capable of transmitting only low-speed electrical signals below 5 Gbps for aligning the substrate to the system board and for insertion into and connecting to a geometrically matching array of through-hole connections on the system board.

2. The device of claim 1, further comprising a plurality of components susceptible to structural failure at high temperatures, including: an optical fiber optically coupled with an adhesive joint to the photonic integrated circuit; and at least one wire bond connecting the photonic integrated circuit to the substrate.

3. The device of claim 2, wherein the perimeter pin array comprises at least one flat pin, and a first local soldering joint for connecting said at least one flat pin to a corresponding first surface mount pad on the system board matching in relative position said at least one flat pin.

4. The device of claim 2 wherein the perimeter pin array comprises at least one gull wing pin capable of transmitting the high-speed electrical signals and radio frequency signals between the substrate and the system board, and a second local soldering joint for connecting said at least one gull wing pin to a corresponding second surface mount pad on the system board matching in relative position said at least one gull wing pin.

5. The device of claim 1, wherein the hybrid pin array further comprises an array of local soldering joints for connecting the pin grid array to the array of through-hole connections at a side of the system board opposite to the substrate.

6. The device of claim 1, wherein the hybrid pin array further comprises a matching connector socket mounted on a side of the system board opposite to the substrate for frictionally fitting and electrically connecting to the pin grid array.

7. The device of claim 1, wherein the pin grid array comprises an array of press-fit pins for frictional insertion into the array of through-hole connections.

8. A method of electrically connecting a high-speed optoelectronic device to a system board, wherein said optoelectronic device includes a photonic integrated circuit mounted on and electrically connected to a substrate and is susceptible to structural failure at high temperatures, said method comprising establishing a hybrid electrical connection between the substrate and the system board, including establishing a first electrical connection capable of transmitting high-speed electrical signals above 5 Gbps, and establishing a second electrical connection capable of transmitting only low-speed electrical signals below 5 Gbps.

9. The method of claim 8, wherein establishing the second electrical connection comprises aligning a pin grid array connected to the substrate to a geometrically matching array of through-hole connections at the system board and inserting the pin grid array into said array of through-hole connections.

10. The method of claim 9, wherein the pin grid array comprises an array of press-fit pins; and wherein establishing the second electrical connection further comprises frictionally inserting the array of press-fit pins into the array of through-hole connections.

11. The method of claim 9, wherein establishing the first electrical connection comprises local soldering at least one flat pin connected to the substrate to a corresponding first surface mount pad at the system board matching in relative position the at least one flat pin.

12. The method of claim 9, wherein establishing the first electrical connection comprises local soldering at least one gull wing pin connected to the substrate and capable of transmitting the high-speed electrical signals and radio-frequency signals, to a corresponding second surface mount pad at the system board matching in relative position the at least one gull wing pin.

13. The method of claim 9, wherein establishing the second electrical connection further comprises locally soldering the pin grid array to the array of through-hole connections at a side of the system board opposite to the substrate.

14. The method of claim 9, wherein establishing the second electrical connection further comprises frictionally inserting the pin grid array into a matching connecter socket mounted on a side of the system board opposite to the substrate.

15. A hybrid pin array apparatus attached and electrically connected to a substrate for connecting to a system board a high-speed optoelectronic device susceptible to structural failure at high temperatures and electrically connected to the substrate, said hybrid pin array apparatus comprising:
a perimeter pin array capable of transmitting high-speed electrical signals above 5 Gbps; and
a pin grid array capable of transmitting only low-speed electrical signals below 5 Gbps for insertion into and electrically connecting to a geometrically matching array of through-hole connections on the system board and for aligning the substrate to the system board.

16. The apparatus of claim 15, wherein the perimeter pin array comprises at least one flat pin, and a first local soldering joint between said at least one flat pin and a corresponding first surface mount pad on the system board matching in relative position said at least one flat pin.

17. The apparatus of claim 15, wherein the perimeter pin array comprises at least one gull wing pin capable of transmitting the high-speed electrical signals and radio frequency signals, and a second local soldering joint between said at least one gull wing pin and a corresponding second surface mount pad on the system board matching in relative position said at least one gull wing pin.

18. The apparatus of claim 15, wherein the pin grid array further comprises an array of local soldering joints at a side of the system board opposite to the substrate for connecting to the contact array.

19. The apparatus of claim 15, further comprising a matching connector socket mounted on a side of the system board opposite to the substrate for frictionally fitting and electrically connecting to the pin grid array therein.

20. The apparatus of claim 15, wherein the pin grid array comprises an array of press-fit pins for frictional insertion into the array of through-hole connections.
